(19) United States
(12) Patent Application Publication
(10) Pub. No.: US 2008/0316656 A1
(43) Pub. Date: Dec. 25, 2008

(54) Magnetic head and method of manufacturing the magnetic head

(76) Inventors: Kazuhito Miyata, Kanagawa (JP); Kentarou Namiki, Kanagawa (JP); Nobuto Yasui, Kanagawa (JP); Hideaki Tanaka, Kanagawa (JP); ATsuko Okawa, Yokohama (JP); Akihiro Namba, Kanagawa (JP); Yoshiki Yonamoto, Yokohama (JP)

Correspondence Address: TOWNSEND AND TOWNSEND AND CREW LLP, TWO EMBARCADERO CENTER, 8TH FLOOR, SAN FRANCISCO, CA, 94111, US

(21) Appl. No.: 12/214,748

(22) Filed: Jun. 20, 2008

(30) Foreign Application Priority Data
Jun. 22, 2007 (JP) 2007-164838

(51) Int. Cl. G11B 5/127

(52) U.S. Cl. 360/324.2; 29/603.16

(57) ABSTRACT

Embodiments of the present invention provide a magnetic head suitable for high density recording at a high yield by reducing the thickness of an air-bearing surface protection layer of a magnetic head and suppressing reduction in the signal-to-noise (S/N) ratio of a read element. According to one embodiment, a read element of a magnetic head has a magnetoresistive effect film (TMR film) between a lower magnetic shield layer and an upper magnetic shield layer, and has a refill film and a magnetic domain control film in both sides of the TMR film. The TMR film is configured by a lower metal layer, an antiferromagnetic layer, a ferromagnetic pinned layer, an intermediate layer, a ferromagnetic free layer, and an upper metal layer. An air-bearing surface protection layer, including a silicon nitride film about 2.0 nm in thickness, is formed on a recording medium facing surface of the TMR film. Since silicon in the silicon nitride film is inactivated by nitrogen, the silicon does not damage the TMR film. Therefore, noise of the read element can be controlled to be at a low level.

### CROSS-REFERENCE TO RELATED APPLICATION

The instant nonprovisional patent application claims priority to Japanese Patent Application No. 2007-164838 filed Jun. 22, 2007 and which is incorporated by reference in its entirety herein for all purposes.

### BACKGROUND OF THE INVENTION

Recently, the recording density of a magnetic recording/reading device has rapidly increased concurrently with increases in the amount of information to be treated, and a magnetic head having high sensitivity and high output power is increasingly required in accordance with such tendency. To meet such requirement, a magnetic head using a GMR (Giant Magnetoresistive) film, which may provide high output power, has been developed, and furthermore variously improved so far. However, even in the magnetic head using the GMR film, output power may be possibly insufficient for recording density larger than 9.3109 bits/cm². Therefore, as a next-generation magnetoresistive film subsequent to the GMR film, research and development has focused on a magnetic head using a tunnel magnetoresistive effect (TMR) film, or a CPP (Current Perpendicular to the Plane) GMR film that flows a current so as to penetrate stacked surfaces of GMR.

The magnetic head using the TMR film or the CPP-GMR film has a significantly different structure compared with the magnetic head using the conventional GMR film. In the latter case, the magnetic head has a CIP (Current Into the Plane) structure that flows a sense current in a film plane direction of a magnetoresistive effect film including a GMR film, and electrodes for supplying the sense current are provided in both sides of the magnetoresistive effect film. On the other hand, in the former case, since the magnetic head has a CPP structure in which the sense current is flown in a perpendicular direction to a film plane of the magnetoresistive effect film such as TMR film or CPP-GMR film, electrodes for supplying the sense current are provided to be stacked on the magnetoresistive effect film.

In the magnetic head having the CPP structure, as described below, magnetic properties may be greatly degraded in a process during manufacturing the magnetic head. First, in the magnetic head having the CPP structure, the sense current flows perpendicularly to stacked surfaces in a thickness direction of the magnetoresistive effect film between an upper magnetic shield and a lower magnetic shield. Therefore, when a circuit, which short-circuits the upper magnetic shield as one electrode to the lower magnetic shield as the other electrode, exists in the magnetic head having the CPP structure, the circuit may become a short-circuit of the sense current, resulting in a decrease in reading output of the magnetic head. Moreover, “Broad-band noise spectroscopy of giant magnetoresistive read heads”, IEEE transactions on magnetics, 41, 2307 (2005), Klaas B. Klaassen et al. (“non-patent document 1) describes that when a magnetic head is not appropriately manufactured and thus has some defects in the magnetoresistive effect film, the magnetic head has large noise.

The short circuit or the defects may be formed on an end face of the magnetoresistive effect film. When the magnetoresistive effect film is processed by ion milling or mechanical polishing, a short circuit or a damaged area is formed on an end face to be formed, which may degrade magnetic properties of a magnetic head. Several methods have been proposed for the purpose of inhibiting formation of the short circuit or the damaged area which may degrade original properties of the magnetoresistive effect film. Japanese Patent Publication No. 2003-086861 (“Patent document 1) discloses an approach for removing the short circuit by performing oxidation treatment to a side face of a magnetoresistive effect film after being subjected to ion milling.

An air-bearing surface protection layer formed on an air-bearing surface of a slider of a magnetic head must have sufficient corrosion resistance and sufficient wear resistance to protect the magnetoresistive effect film from corrosion and wear. On the other hand, since magnetic spacing as a distance between the magnetic head and a magnetic disk is essentially reduced in accordance with increase in recording density of the magnetic disk recording/reading device, the air-bearing surface protection layer must be small in thickness.

To concurrently meet the above requirements, studies have been made on a technique for reducing thickness of the air-bearing surface protection layer while keeping the corrosion resistance and wear resistance. Currently, a double-layer film configured by an upper layer of a carbon film and an adhesion layer of an amorphous silicon film is used for the air-bearing surface protection layer. Since the carbon film is tough and chemically inactive, the film has sufficient corrosion resistance and sufficient wear resistance. Since the carbon film generally has high internal stress, the film is hard to be directly adhered to a substrate. On the contrary, since the amorphous silicon film has low internal stress, it reduces the internal, compressive stress of the carbon film, and consequently improves adhesion.

The carbon film in the air-bearing surface protection layer is formed using chemical vapor deposition (CVD) or filtered cathodic vacuum arc (FCVA) deposition. The carbon film includes a diamond component and a graphite component, and the carbon film formed using the above method is relatively much in diamond component and thus tough, consequently the carbon film exhibits relatively excellent wear resistance even if the thickness is small. When the above method is used, a carbon film having a thickness of 1.5 nm or more is formed, whereby sufficient corrosion resistance and sufficient wear resistance can be achieved. Currently, an air-bearing surface protection layer including a carbon film 1.5 nm thick and a silicon film 1.0 nm thick is formed using these techniques.

To achieve further reduction in thickness of the air-bearing surface protection layer, Japanese Patent Publication No. 2006-107607 (“patent document 2”) discloses a method of manufacturing an air-bearing surface protection layer including only a carbon thin film. By using this technique, an air-bearing surface protection layer is formed with only the carbon film that contributes to corrosion resistance and wear resistance, whereby reduction in thickness can be achieved while keeping corrosion resistance and wear resistance.

It was found that in a magnetic head using the TMR film in which the intermediate layer was a tunnel barrier layer, when the thickness of the air-bearing surface protection layer was made less than 2.5 nm to meet the requirement of increased recording density, a considerably large number of magnetic heads were low in S/N ratio of a read element, and therefore they were not able to exhibit desired properties.

### BRIEF SUMMARY OF THE INVENTION

Embodiments of the present invention provide a magnetic head suitable for high density recording at a high yield by reducing the thickness of an air-bearing surface protection layer of a magnetic head and suppressing reduction in the S/N ratio of a read element. According to the embodiment of FIG. 1, a read element 12 of a magnetic head 1 has a magnetoresistive effect film (TMR film) 2 between a lower magnetic shield layer 14 and an upper magnetic shield layer 16, and has a refill film 18 and a magnetic domain control film 19 in both sides of the TMR film 2. The TMR film 2 is configured by a lower metal layer 3, an antiferromagnetic layer 4, a ferromagnetic pinned layer 5, an intermediate layer 6, a ferromagnetic free layer 7, and an upper metal layer 8. An air-bearing surface protection layer 100, including a silicon nitride film about 2.0 nm in thickness, is formed on a recording medium facing surface 9 of the TMR film 2. Since silicon in the silicon nitride film is inactivated by nitrogen, the silicon does not damage the TMR film 2. Therefore, noise of the read element 12 can be controlled to be at a low level.

### BRIEF DESCRIPTION OF THE DRAWINGS

FIG. 1 shows an enlarged section view in an element height direction of a TMR film of a magnetic head according to example 1;

FIG. 2 shows a cross section view in a track width direction of a read element of the magnetic head according to the example 1;

FIG. 3 shows a cross section view along line B-B in FIG. 2;

FIG. 4 shows a perspective view of a magnetic head row bar;

FIG. 5 shows a general perspective view of the magnetic head according to embodiments of the invention;

FIG. 6 shows a cross section view along line A-A in FIG. 5;

FIG. 7 shows a process flow chart showing a method of manufacturing the magnetic head according to the example 1;

FIG. 8 shows a constructive view of a deposition apparatus (sputtering apparatus) of a silicon nitride film;

FIG. 9 shows a view for illustrating an effect of the magnetic head according to the example 1;

FIG. 10 shows a cross section view in a track width direction of a read element of a magnetic head according to example 2;

FIG. 11 shows a process flow chart showing a method of manufacturing the magnetic head according to the example 2;

FIG. 12 shows a constructive view of a deposition apparatus (cathodic vacuum arc deposition apparatus) of a carbon film;

FIG. 13 shows a view for illustrating an effect of the magnetic head according to the example 2; and

FIG. 14 shows a constructive view of a deposition apparatus (sputtering apparatus) of a carbon film.

### DETAILED DESCRIPTION OF THE INVENTION

Embodiments of the present invention relate to a magnetic head having a magnetoresistive effect element, and a method of manufacturing the magnetic head.

An object of embodiments of the invention is to provide a magnetic head suitable for high density recording at a high yield by reducing the thickness of an air-bearing surface protection layer of a magnetic head, in addition, suppressing reduction in the S/N ratio of a read element.

In conducting a detailed investigation on a conventional manufacturing method in order to achieve a high-yield magnetic head, it was found that reduction in the S/N ratio of a read element of a magnetic head was caused by the following mechanism.

When an intermediate layer, a ferromagnetic pinned layer, or a ferromagnetic free layer in a magnetoresistive effect film is damaged, such a damaged portion becomes a trap site that easily captures an electron. Coulomb potential is different between a case that an electron is trapped in the damaged portion as the trap site, and a case that the damaged portion is empty, and consequently electric resistance is varied (fluctuates). The fluctuation of electric resistance acts as noise in detection of a magnetic field.

The damage is induced by a phenomenon that a material configuring a magnetoresistive effect film chemically reacts with a reactive material at an end face of the film. One end face (recording medium facing surface) of the magnetoresistive effect film is exposed to an air-bearing surface side, and directly contacts to the air-bearing surface protection layer. The carbon film configuring the upper layer of the air-bearing surface protection layer and the silicon film configuring the adhesion film as the lower layer thereof are extremely reactive with the magnetoresistive effect film. Furthermore, when the silicon film is compared to the carbon film, the carbon film more significantly damages the magnetoresistive effect film. From the above, when the conventional air-bearing surface protection layer configured by the silicon film and the carbon film is used, first, increases in noise is observed due to a reaction between silicon configuring the adhesion film and the magnetoresistive effect film. Furthermore, when the thickness of the adhesion film is reduced due to reduction in thickness of the air-bearing surface protection layer, and consequently carbon may contact to the magnetoresistive effect film, more trap sites are formed in a medium facing surface configuring part of the air-bearing surface of the magnetoresistive effect film, resulting in increases in noise, namely, reduction in the S/N ratio.

Principally, if even a single layer of adhesion film exists, the air-bearing surface protection layer including a carbon film does not contact to the magnetoresistive effect film. However, in the conventional technique, when the air-bearing surface protection layer is formed, since carbon is irradiated to an air-bearing surface of a magnetic head as ions having energy of about 50 eV, the carbon somewhat enters into the adhesion film, and some of the ions may penetrate the film. Thus, the carbon may react with the magnetoresistive effect film under the adhesion film. In the case of using the conventional technique, when the thickness of the adhesion film is decreased to less than 1.0 nm, the carbon directly contacts to an end face of the magnetoresistive effect film.

Since a carbon film 1.5 nm or more in thickness must be formed to achieve sufficient corrosion resistance and sufficient wear resistance, when an air-bearing surface protection layer less than 2.5 nm in thickness is formed, the adhesion film must be less than 1.0 nm in thickness, causing reduction in the S/N ratio.

In the light of the above mechanism, the inventors found that a magnetic head was configured such that a single-layer silicon nitride film was used for the air-bearing surface protection layer, and carbon was not present in the medium facing surface of the magnetoresistive effect film, whereby in a magnetic head using a magnetoresistive effect film having an intermediate layer including an oxide, even if the thickness of the air-bearing surface protection layer was less than 2.5 nm, a good S/N ratio was obtained.

The silicon nitride film is used for the air-bearing surface protection layer, so that silicon is inactivated by nitrogen in the silicon nitride film. Thus, the reaction between the magnetoresistive effect film and the air-bearing surface protection layer is suppressed, consequently increases in noise can be prevented. A component ratio of nitrogen in the silicon nitride film is preferably 35 atomic percent or more and 60 atomic percent or less.

When the air-bearing surface protection layer is configured to be at least two layers of the silicon nitride film and the carbon film, the thickness of the silicon nitride film is made large compared with the entering depth of carbon in formation of the carbon film, or the energy of carbon in formation of the carbon film is reduced such that the carbon does not penetrate the silicon nitride film, whereby a reaction between the magnetoresistive effect film and the silicon nitride film or the carbon film is suppressed, consequently increases in noise can be prevented. A detailed mechanism of this is described below.

When a carbon film is formed using carbon ions having energy Ei, since the carbon ions are irradiated to the adhesion film, the carbon ions somewhat enter into the adhesion film, resulting in a reaction of the carbon ions with the magnetoresistive effect film under the adhesion film. The entering depth of a carbon ion into the adhesion film can be calculated as follows. After colliding with the adhesion film, the carbon ion enters into the adhesion film while losing the initial energy Ei. The carbon ion stops at a depth at which the energy of the carbon ions becomes zero. In this process, power of the adhesion film for decelerating the carbon ions is called stopping power (dE/dx). The stopping power means energy lost by a particle while the particle enters to a depth of unit length, and as the number of electrons is increased, that is, as the adhesion film is denser, the stopping power is increased. From the stopping power and energy of an injected particle, the entering depth d can be expressed by the following expression.

D=Ei/(dE/dx)

This shows that one of the following conditions may be satisfied to isolate between the carbon film and the magnetoresistive effect film. That is, since it is only necessary that the entering depth d is smaller than the thickness t of the adhesion film, (1) the thickness t of the adhesion film is larger than a quotient obtained by dividing the injection energy of carbon ions by stopping power of the adhesion film, (2) the injection energy of a carbon particle in formation of the carbon film is smaller than a product of multiplying the thickness t of the adhesion film by the stopping power dE/dx, and (3) the stopping power dE/dx of the adhesion film is larger than a quotient obtained by dividing the injection energy Ei of the carbon particle in formation of the carbon film by the thickness t of the adhesion film. The air-bearing surface protection layer is formed such that any one of the three conditions is satisfied, whereby the carbon film can be isolated from the magnetoresistive effect film. It is also means for solving the problem that the air-bearing surface protection layer is configured such that the air-bearing surface protection film (upper layer) does not contain carbon.

According to the above configurations, a magnetic head having small noise can be obtained in thickness of the air-bearing surface protection layer of less than 2.5 nm while the magnetoresistive effect film is not contacted to silicon and carbon.

According to embodiments of the invention, the thickness of the air-bearing surface protection layer can be decreased without damaging the magnetoresistive effect film. As a result, a magnetic head that is high in yield and suitable for high recording density can be obtained.

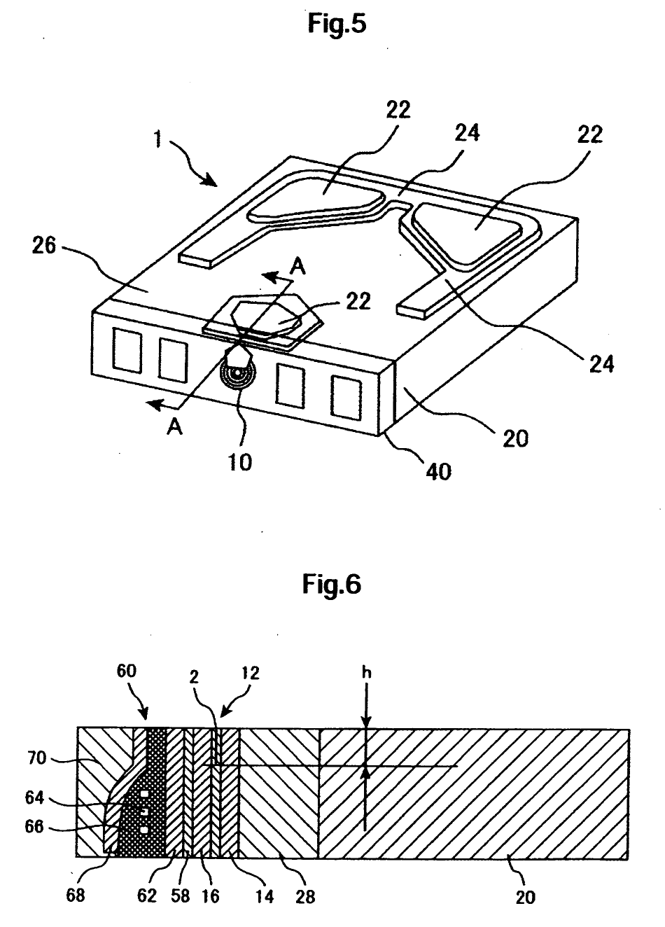

First, a basic configuration of a magnetic head according to embodiments of the invention is described with reference to FIGS. 4, 5 and 6. FIG. 4 shows a perspective view of a row bar cut out from a wafer. FIG. 5 shows a perspective view of a magnetic head being separated from one another by cutting the row bar. FIG. 6 shows a section along line A-A in FIG. 5, which shows a cross section view of a magnetic head element portion. A row bar 50 includes about 50 magnetic head elements connected to one another, and has a length L of about 50 mm and a thickness t of about 0.3 mm. A magnetic head 1 has a slider 20 and an element formation portion 40, wherein a magnetic head element 10 is formed on the element formation portion 40. On an air-bearing surface (medium facing surface) of the magnetic head 1, a fly rail 22, a shallow groove rail 24, and a deep groove 26 are formed. As shown in FIG. 6, the magnetic head element 10 is configured by a read element 12 and a write element 60, the elements being stacked with an insulating film 28 between them on an end face of the slider 20 including a ceramic material. The read element 12 is configured by a lower magnetic shield layer 14, a magnetoresistive effect film 2, and an upper magnetic shield layer 16. Element height from the air-bearing surface of the magnetoresistive effect film 2 is shown by h. The write element 60 is a magnetic induction element stacked on an insulating isolation film 58 formed on the upper magnetic shield layer 16, and configured by a lower magnetic film 62, a coil 64, an interlayer insulating film 66, and an upper magnetic film 68. An upper part of the write element 60 is covered with an insulating protection film 70.

While the magnetic head 1 is a recording/reading magnetic head having the read element 12 and the write element 60, the read element may be separated from the write element. In such a case, the magnetic head 1 is configured to have a read element 12 including a TMR film 2.

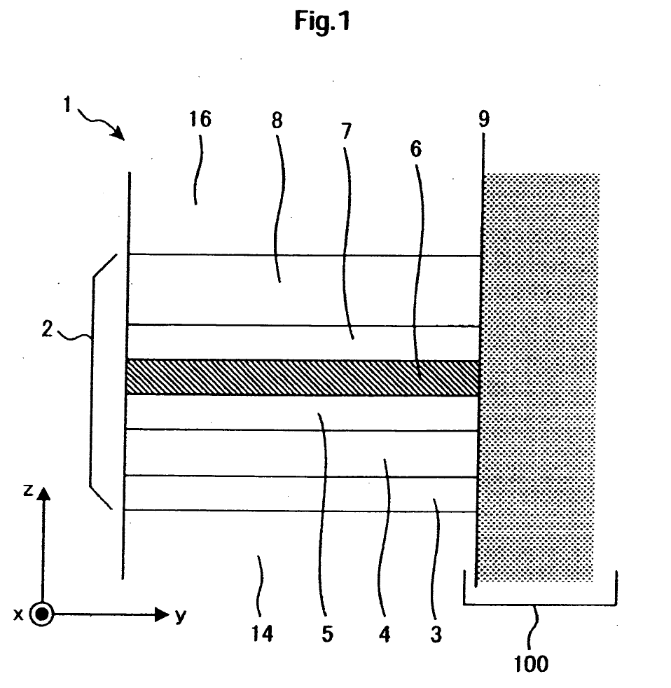

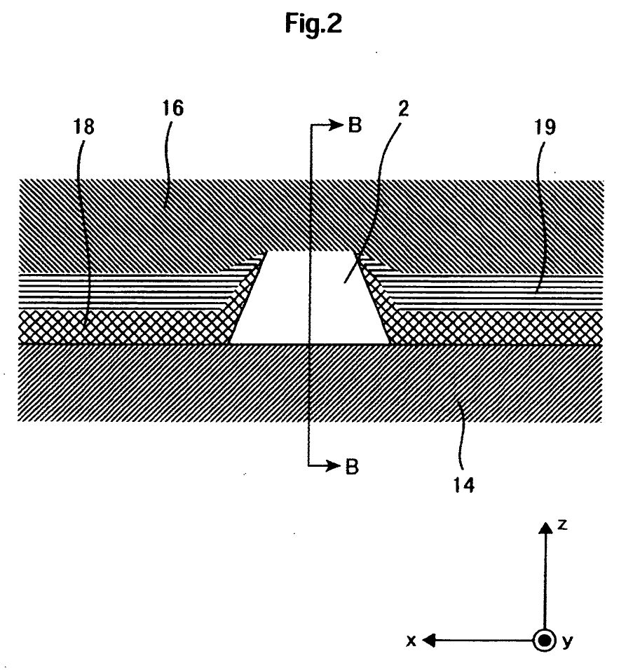

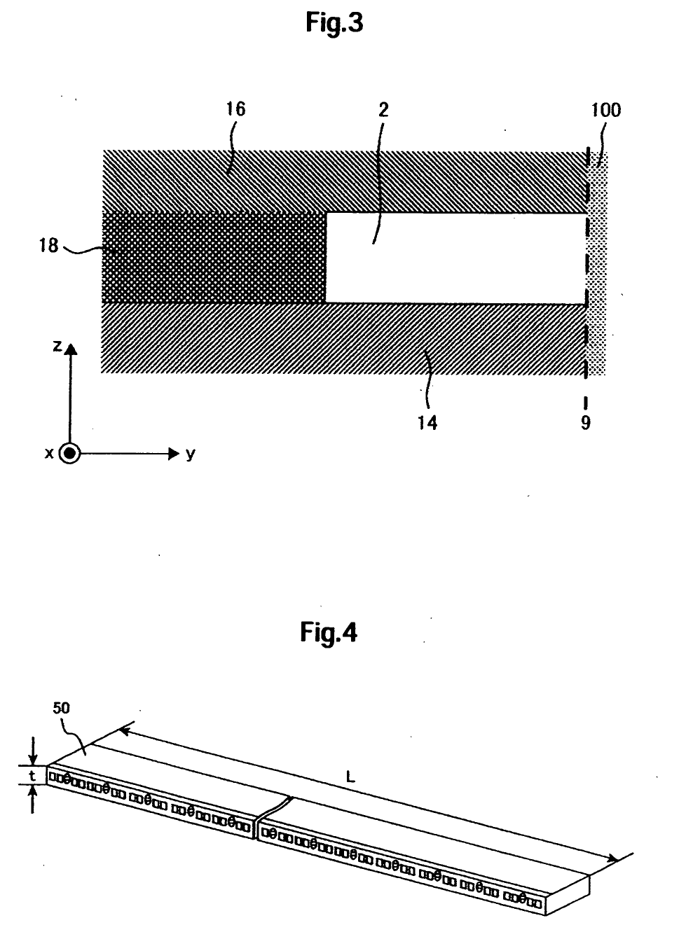

Next, a configuration of a portion of the read element and a portion of the air-bearing surface protection layer of a magnetic head according to example 1 is described with reference to FIGS. 1, 2 and 3. FIG. 2 shows a view showing a section parallel to a medium surface of the magnetic head (section perpendicular to an element height direction), and an X axis, a Y axis and a Z axis in the figure show a track width direction, an element height direction, and a stacked film thickness direction respectively. FIG. 3 shows a cross section view in the element height direction taking along line B-B in FIG. 2. FIG. 1 shows an enlarged view of an end face forming part of a medium facing surface in FIG. 3. In each of FIGS. 1 and 3, an X axis, a Y axis and a Z axis are the same as the X axis, Y axis and Z axis as shown in FIG. 2, respectively.

As shown in FIG. 2, the read element 12 has the magnetoresistive effect film (TMR film) 2 between the lower magnetic shield layer 14 and the upper magnetic shield layer 16, and has a refill film 18 and a magnetic domain control film 19 in both sides of the TMR film 2. The TMR film 2 is configured by at least a lower metal layer 3, an antiferromagnetic layer 4, a ferromagnetic pinned layer 5, an intermediate layer 6, ferromagnetic free layer 7, and an upper metal layer 8, those being sandwiched by the lower magnetic shield layer 14 and the upper magnetic shield layer 16. It is featured that resistance is changed by an angle formed by magnetization of the ferromagnetic pinned layer 5 and magnetization of the ferromagnetic free layer 7, the layers 5 and 7 being isolated by the intermediate layer 6. By reading such resistance change, an external magnetic field can be measured. An air-bearing surface protection layer 100 is formed on a recording medium facing surface 9 of the TMR film 2. The air-bearing surface protection layer 100 includes a single-layer silicon nitride film about 2.0 nm in thickness.

For the lower magnetic shield layer 14 and the upper magnetic shield layer 16, a soft magnetic material including Ni—Fe alloy is used. For the lower metal layer 3, Ta, Ru, Ni—Fe alloy, or a stacked film of them is used. For the antiferromagnetic layer 4, an antiferromagnetic material such as Pt—Mn alloy or Mn—Ir alloy, or a hard magnetic material such as Co—Pt alloy or Co—Cr—Pt alloy is used. As the hard magnetic material film, a film with high coercivity in antiparallel coupling, so-called self-pinned film may be used. For the ferromagnetic pinned layer 5 and the ferromagnetic free layer 7, a highly-polarized material such as Ni—Fe alloy, Co—Fe alloy, Co—Ni—Fe alloy, magnetite, or Heusler alloy, and a stacked film of them can be used. Moreover, a multilayer film may be used, which includes ferromagnetic layers stacked with a spacer layer 1 nm or less in thickness between them. In the case of using the TMR effect, the intermediate layer 6 acts as a tunnel barrier layer, and specifically an oxide of Al, Mg, Si, Zr, Ti, or a mixture of oxides of them, or a stacked body of the oxides can be used for the intermediate layer, and magnesium oxide (MgO) is used in the example. For the upper metal layer 8, Ta, Ru, Ni—Fe alloy, or a stacked film of them is used.

A stacking order of layers of the TMR film is not limited to the above, and for example, the lower metal layer, ferromagnetic free layer, intermediate layer, ferromagnetic pinned layer, antiferromagnetic layer, and upper magnetic layer may be stacked in this order on the lower magnetic shield layer 14, and then the upper magnetic shield layer 16 may be stacked thereon.

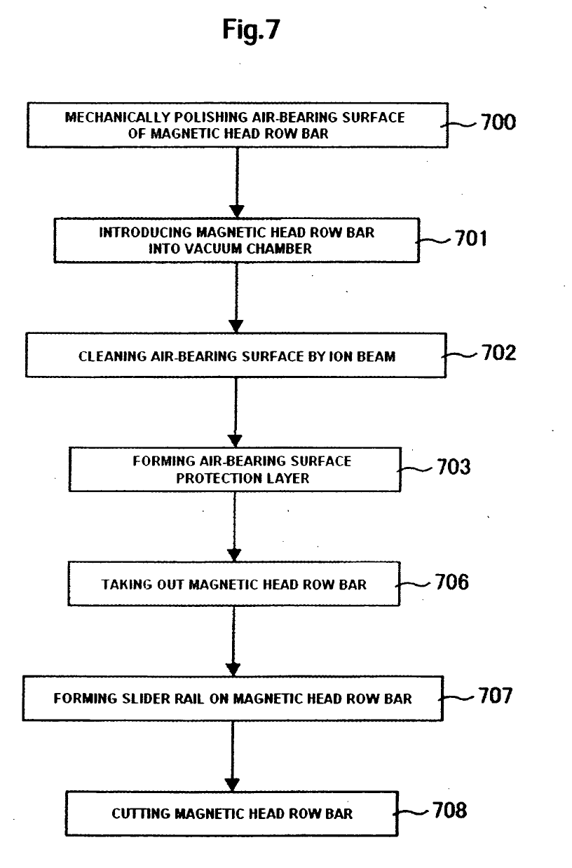

Next, a method of manufacturing the magnetic head according to example 1 is described using FIG. 7. First, a base material of alumina-titanium carbide, on which a plurality of magnetic head elements are formed, is cut into a strip-like magnetic head row bar 50 as shown in FIG. 4. Then, a surface to be processed of the magnetic head row bar 50 is subjected to mechanical polishing by using, for example, a rotational plate buried with diamond abrasive-grains such that each dimension of the magnetic head element (element height h and the like) has a desired value (step 700).

After the mechanical polishing is finished, the magnetic head row bar 50 is guided into a vacuum chamber (step 701). The medium facing surface 9 of the magnetic head row bar 50 is subjected to cleaning by argon ion beam irradiation in the vacuum chamber (step 702). Ions of a noble gas such as neon, helium, krypton, or xenon can be used as the ions in addition to argon ions. An acceleration voltage of an ion beam is 300 V, and an ion incidence angle is 75 degrees from a normal to the medium facing surface. However, such a condition is not restrictive as long as a conductive smear caused by a plastic flow layer, which is formed in a step of the mechanical polishing, can be removed. Moreover, sputter etching by gas plasma can be used in place of ion beam irradiation.

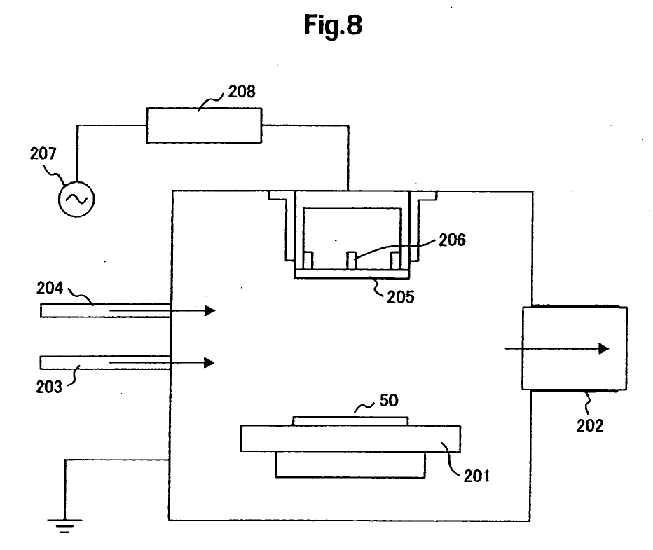

Following the cleaning step, the magnetic head row bar 50 is taken out from the vacuum chamber, then the row bar 50 is carried in a vacuum into a deposition apparatus shown in FIG. 8, and then the air-bearing surface protection layer 100 including the silicon nitride film is formed according to the following method (step 703). The magnetic head row bar 50 is fixed to a sample holder 201 of the deposition apparatus. Then, the deposition apparatus is evacuated to about 110-4 Pa by a vacuum pump 202. Then, gas is introduced into a vacuum chamber by using an argon gas manifold 203 and a nitrogen gas manifold 204. Here, argon gas and nitrogen gas were introduced at 3 sccm and 15 sccm, respectively. In the vacuum chamber, a silicon target 205 is provided at a place opposed to the sample holder 201. The silicon target 205 is connected to an RF power supply 207 via a matching box 208. The RF power supply 207 supplies power so that plasma is generated between the silicon target 205 and the sample holder 201, and thereby ions and radicals of argon and nitrogen are generated. A magnet 206 is disposed near the silicon target 205, so that the silicon target 205 is affected by a magnetic field. The silicon target 205 is sputtered by the ions and the radicals of argon and nitrogen generated in the magnetic field, so that silicon is deposited on the magnetic head row bar 50 on the sample holder 201. During this, silicon reacts with nitrogen in the atmosphere, so that a silicon nitride film is formed on the magnetic head row bar. According to this process, a silicon nitride film 2.0 nm in thickness was formed on the magnetic head row bar. The silicon nitride film had a component ratio of nitrogen of about 55 atomic percent, which was extremely similar to a stoechiometric composition. The component ratio of nitrogen is preferably in a range of 35 atomic percent to 60 atomic percent.

Returning to FIG. 7 again, after formation of the air-bearing surface protection layer, the magnetic head row bar 50 is taken out from the vacuum chamber (step 706), then resist coating, exposure, and ion milling are repeated to form a slider rail (step 707), and finally the magnetic head row bar 50 is mechanically cut into magnetic head elements, so that the magnetic head 1 is completed (step 708).

As a film formation method of the silicon nitride film, in addition to the reactive sputtering, ion-beam deposition in which directional argon ions and directional nitrogen ions are irradiated in a beam to the silicon target so that the silicon target is sputtered for silicon nitride film formation may be used, in addition, thermal evaporation, CVD and the like may be used. Moreover, the thickness of the film may be less than 2.0 nm as long as corrosion resistance is satisfied.

Advantages of the example 1 are described with a relationship with comparative example 1. A magnetic head of the comparative example 1 has the same configuration as in the example 1 except for a composition and a formation method of an air-bearing surface protection layer, and it was prepared by the same manufacturing method. The air-bearing surface protection layer in the comparative example 1 was formed as follows: a magnetic head row bar was subjected to mechanical polishing, then carried into a vacuum chamber and subjected to cleaning by ion beam irradiation therein, and then the air-bearing surface protection layer was formed using the deposition apparatus shown in FIG. 8. In such a process, argon gas and nitrogen gas were introduced into the apparatus in the following four conditions, and RF power was supplied for reactive sputtering. (1) argon/nitrogen=18 sccm/0 sccm, (2) argon/nitrogen=17 sccm/1 sccm, (3) argon/nitrogen=15 sccm/3 sccm, and (4) argon/nitrogen=12 sccm/6 sccm. Silicon nitride films formed according to the conditions had component ratios of nitrogen of 0 atomic percent, 10 atomic percent, 20 atomic percent, and 30 atomic percent respectively.

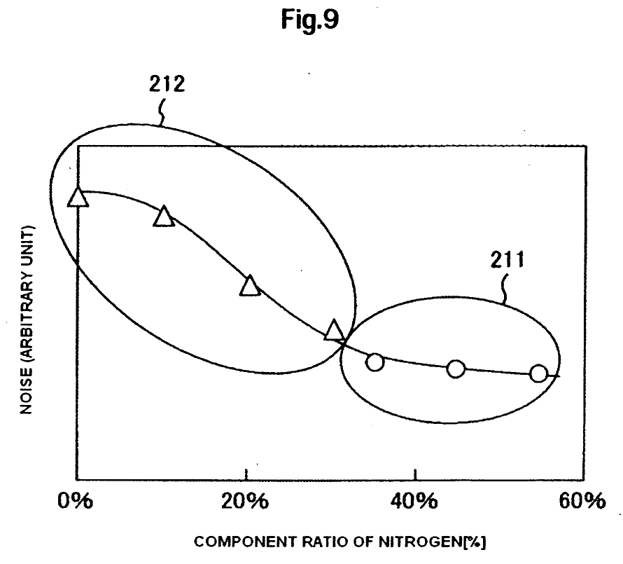

Next, the magnetic head of the example 1 and the magnetic head of the comparative example 1 were subjected to noise measurement. Noise of the magnetic head was measured using the following method. First, lead wires, which are connected to the lower magnetic shield layer 14 and the upper magnetic shield layer 16 provided below and above the TMR film 2 of the magnetic head respectively, are connected to a voltage meter. Then, a sense current is flown into the TMR film 2 using a constant-current power supply, and fluctuation of a voltage is measured for 0.1 sec at a sampling frequency of 5 MHz through a bandpass filter of 1 MHz to 50 MHz. Standard deviation of voltage values measured in such a way may be an index of noise. In FIG. 9, a component ratio of nitrogen in the silicon nitride film is plotted in a horizontal axis, and the described noise is plotted in a vertical axis. Measurement examples 211 of the magnetic head of the example 1 are shown by circles, and measurement examples 212 of that of the comparative example 1 are shown by triangles. In the magnetic head of the example 1, since silicon is inactivated by nitrogen in the silicon nitride film, causing no damage in the TMR film 2, therefore noise is controlled to be at a low level. On the contrary, in the magnetic head of the comparative example 1, silicon is not sufficiently inactivated in the silicon nitride film, so that the silicon partially reacts with the TMR film 2, which may cause generation of a damaged area, therefore noise is at a high level.

As described above, according to the example 1, the air-bearing surface protection layer is reduced in thickness, and reduction in S/N ratio of the read element is suppressed, whereby a magnetic head suitable for high density recording can be provided at a high yield. Moreover, it was able to be confirmed that a silicon nitride film having a high component ratio of nitrogen was excellent in corrosion resistance and wear resistance, and exhibited sufficient corrosion resistance and sufficient wear resistance in thickness of 2.0 nm.

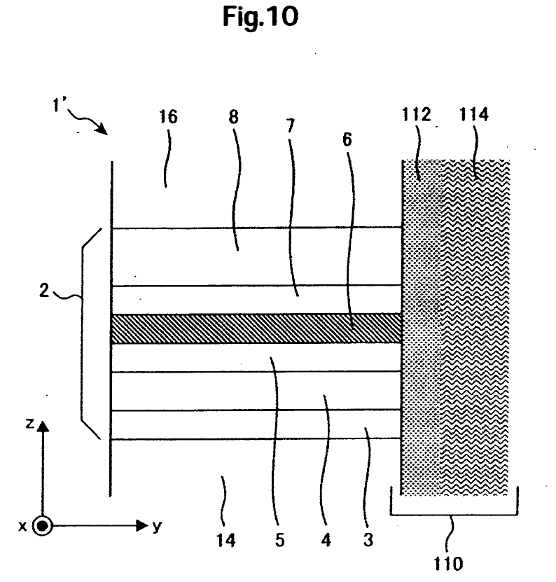

Next, a configuration of a portion of the read element and a portion of an air-bearing surface protection layer of a magnetic head according to example 2 is described with reference to FIG. 10. A configuration of a magnetic head 1 according to the example 2 is the same as in the example 1 except for the air-bearing surface protection layer. Therefore, description of the same configuration as in the example 1 is omitted, and description is made on a configuration of the air-bearing surface protection layer being different from that in the example 1. An air-bearing surface protection layer 110 is configured by stacking an air-bearing surface protection film 114 including a carbon film on an adhesion film 112 including a silicon nitride film. The total thickness of the air-bearing surface protection layer 110 is 2.0 nm.

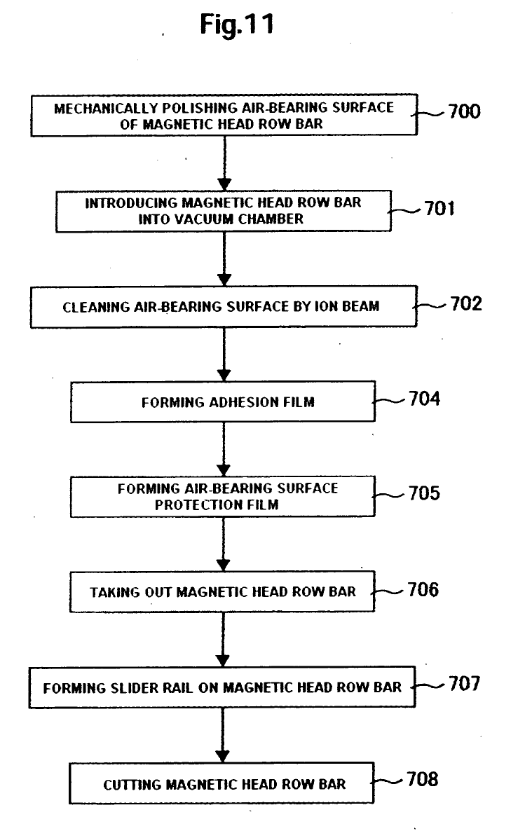

Next, a method of manufacturing the magnetic head according to example 2 is described with reference to FIG. 11. Since the method is the same as the method of manufacturing the magnetic head according to example 1 except for a formation step of the air-bearing surface protection layer, description of the same steps is omitted, and a formation step of the air-bearing surface protection layer is described.

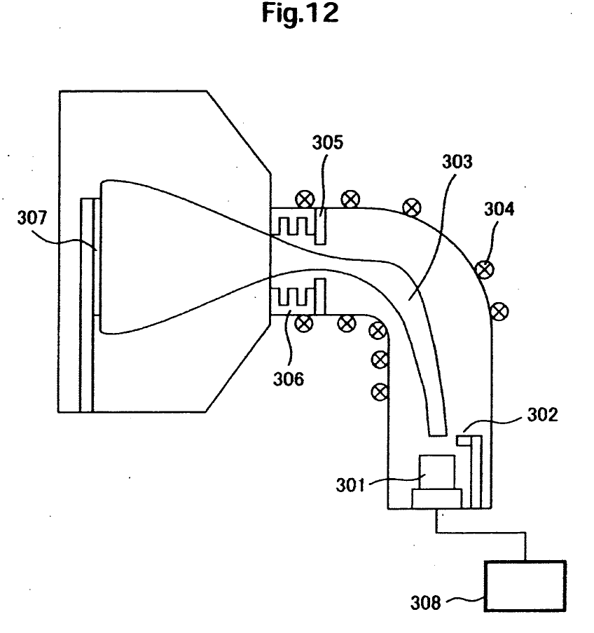

Following a cleaning step (702) by an ion beam, the adhesion film 112 including silicon nitride is formed by sputtering (step 704). The thickness of the adhesion film 112 is 1.0 nm. A film formation method is the same as in the example 1. The film formation method of the adhesion film 112 is not limited to sputtering, and ion-beam deposition, thermal evaporation, and CVD may be used. After formation of the adhesion film 112, the air-bearing surface protection film 114 of 1.0 nm in thickness including carbon is formed as an upper layer using cathodic vacuum arc deposition (step 706). The cathodic vacuum arc deposition is performed using an apparatus shown in FIG. 12. When an anode 302 is contacted to a graphite cathode 301 connected to an arc source 308, a large number of thermoelectrons are emitted, and an electric field is generated near the cathode 301. Carbon ions 303 generated from the cathode 301 due to such arc discharge are accelerated to about 50 to 100 eV, and partially transported into a deposition chamber through a bent duct about 8 inches in diameter. The apparatus is designed such that a coil 304 is wound around the bent duct to generate a magnetic field within the duct. The carbon ions 303 are effectively transported into the deposition chamber by the magnetic field. The carbon ions 303 transported into the deposition chamber collide with the magnetic head row bar 50 set on the sample holder 307 in the deposition chamber, so that the carbon film 114 is formed on the silicon nitride film 112. Each of the generated carbon ions 303 has energy of up to about 100 eV. When the carbon film is formed using the cathodic vacuum arc deposition, particles about several micrometers in size are generated, and a filter 305 and electrodes 306 are set between the duct and the deposition chamber for removing the particles. Some of the particles are charged, therefore the particles can be removed by applying a voltage to the electrodes.

Some kinds of surface treatment may be performed after formation of the air-bearing surface protection film 114 as long as sufficient corrosion resistance and sufficient wear resistance are provided. After the air-bearing surface protection film 114 is formed, the magnetic head row bar is taken out from a vacuum chamber (step 706).

In the magnetic head 1′ according to the example 2, the thickness of the silicon nitride film as the adhesion film 112 is not limited to the above 1.0 nm if carbon ions may not reach the TMR film 2 through the adhesion film 112 in the relevant thickness in a subsequent step of forming the air-bearing surface protection film 114 including carbon. That is, when it is assumed that stopping power of the adhesion film 112 is dE/dx, the thickness of the film is t, and the energy of the carbon ion is Ei, it is enough that t is given so as to satisfy the following expression.

t>Ei/(dE/dx)

The cathodic vacuum arc deposition is used to form the carbon film 114 in the example 2, in which an average value of energy of carbon ions is about 50 eV. While the energy of carbon ions is somewhat distributed, most of the ions have energy of 100 eV or less. Here, since the stopping power dE/dx of the silicon nitride film 112 is about 100 eV/nm, if the thickness of the silicon nitride film 112 is 1.0 nm or more, the carbon ions do not damage the TMR film 2 through the adhesion film 112 including the silicon nitride film, consequently a magnetic head having a good S/N ratio can be manufactured.

Next, advantages of the example 2 are described with a relationship with comparative example 2. Here, description is made on a magnetic head of the comparative example 2 to be compared to the magnetic head of the example 2. The magnetic head of the comparative example 2 has an air-bearing surface protection layer 2.0 nm in thickness as in the example 2, and was prepared as follows. A magnetic head row bar was subjected to mechanical polishing, then carried into a vacuum chamber and subjected to cleaning by ion beam irradiation therein, and then silicon nitride films 0 nm, 0.2 nm, 0.4 nm, 0.6 nm, and 0.8 nm in thickness respectively were formed by reactive sputtering as adhesion films 112. Then, carbon films 2.0 nm, 1.8 nm, 1.6 nm, 1.4 nm, and 1.2 nm in thickness respectively were formed using cathodic vacuum arc deposition. The total thickness of each of the air-bearing surface protection layers formed according to the five conditions is 2.0 nm.

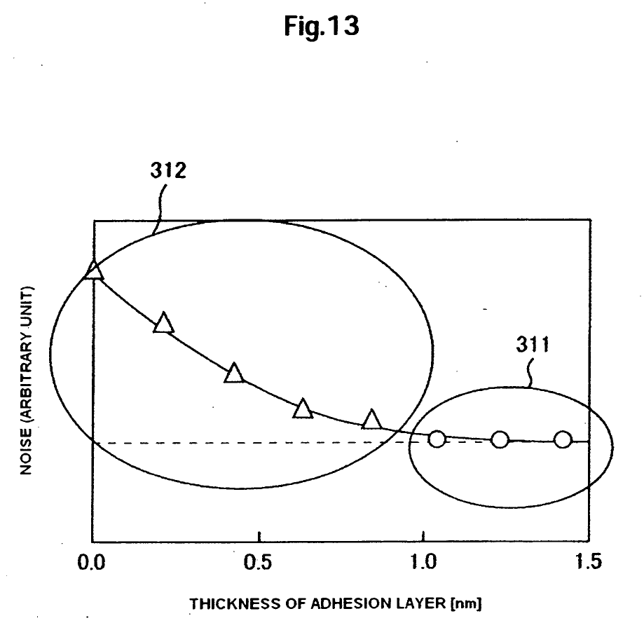

Next, the magnetic heads prepared in the example 2 and the comparative example 2 were subjected to noise measurement. Noise of the magnetic head was measured by the same method as the method carried out in comparison between the example 1 and the comparative example 1. In FIG. 13, the thickness of the adhesion film 112 is plotted in a horizontal axis, and standard deviation of voltage fluctuation of the described noise is plotted in a vertical axis. Measurement examples 311 of the magnetic head 1 according to the example 2 are shown by circles, and measurement examples 312 of the magnetic head of the comparative example 2 are shown by triangles. In the magnetic heads 1 according to the example 2, since carbon does not reach the TMR film 2 in any case, and therefore the TMR film 2 is not damaged, the magnetic head is low in noise, and has a more excellent S/N ratio compared with the comparative example 2 in any case.

In the case that the air-bearing surface protection layer 110 has a double-layer structure of the adhesion film 112 including the silicon nitride film and the air-bearing surface protection film 114 including the carbon film as in the example 2, noise is reduced with increases in the component ratio of nitrogen in the silicon nitride film, and the component ratio of nitrogen is preferably 35 atomic percent or more and 60 atomic percent or less as in the example 1.

According to the example 2, the air-bearing surface protection layer is reduced in thickness, and reduction in S/N ratio of the read element is suppressed, whereby a magnetic head suitable for high density recording can be provided at a high yield as in the example 1. Moreover, since the carbon film is formed as the air-bearing surface protection film (upper layer), corrosion resistance and wear resistance are excellent compared with the example 1.

Next, description is made on another example of a formation method of an air-bearing surface protection layer of the magnetic head according to the example 2. This method is characterized in that the air-bearing surface protection layer 110 is configured by the adhesion film 112 including the silicon nitride film and the air-bearing surface protection film 114 including the carbon film, and when the air-bearing surface protection film 114 is formed, the carbon film is formed by sputtering a carbon target using Ar gas plasma.

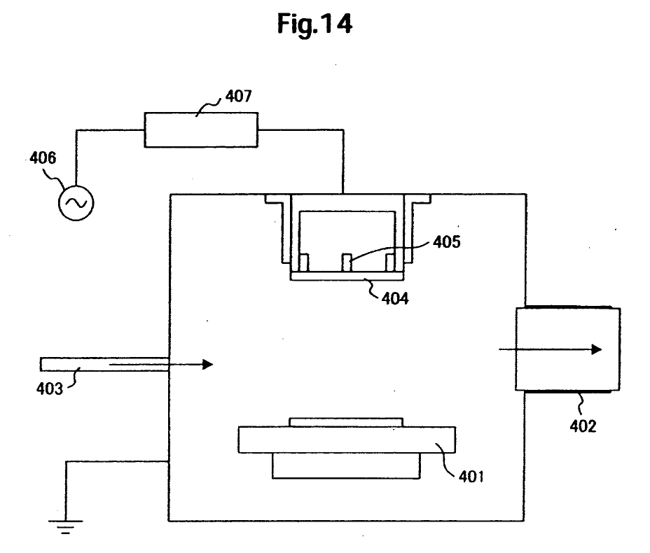

Following a cleaning step by an ion beam, the adhesion film 112 including silicon nitride is formed by sputtering. The thickness of the adhesion film 112 is 0.4 nm. A film formation method of the adhesion film 112 is not limited to sputtering, and ion-beam deposition, thermal evaporation, and CVD may be used. After formation of the adhesion film 112, the air-bearing surface protection film 114 1.6 nm in thickness including carbon is formed using sputtering. The formation of the carbon film by sputtering is performed using an apparatus shown in FIG. 14. The magnetic head row bar is fixed to a sample holder 401. Then, the apparatus is evacuated to about 110-4 Pa by a vacuum pump 402. The degree of vacuum can be appropriately changed. Then, gas is introduced into a vacuum chamber by using an argon gas introduction pipe 403. Here, argon gas was introduced at 15 sccm. In the vacuum chamber, a carbon target 404 is provided at a place opposed to the sample holder 401. The carbon target 404 is connected to an RF power supply 406 via a matching box 407. The RF power supply 406 supplies power so that plasma is generated between the carbon target 404 and the sample holder 401 so that argon ions are generated. The carbon target 404 is affected by a magnetic field generated by a magnet 405. The generated argon ions sputter the carbon target 404, so that a carbon film is deposited on a magnetic head row bar on the sample holder 401. A carbon film 1.6 nm in thickness was formed on the magnetic head row bar using the method.

According to this sputtering method, an atom of carbon, which was sputtered and adhered to the silicon nitride film, has energy of about several electron volts, that is, the atom does not have sufficient energy to penetrate a single layer of the silicon nitride film. Therefore, even if the thickness of the silicon nitride film is 0.4 nm, no reaction occurs between an end face of the TMR film and carbon, and therefore no damage is induced in the TMR film. A magnetic head having the air-bearing surface protection layer formed in this way had a good S/N ratio.

A film formation method of the carbon film need not be limited to the above sputtering, and ion-beam deposition in which directional argon ions are irradiated in a beam to a carbon target so that the carbon target is sputtered for carbon film formation, in addition, thermal evaporation, CVD and the like may be used.

According to the above examples, a magnetic head having a high S/N ratio can be achieved without causing magnetic spacing loss. As a result, a magnetic head suitable for high density recording can be obtained at a high yield.

While the TMR film was used as the magnetoresistive film of the read element in the above examples, the CPP-GMR film may be used. In the case of the CPP-GMR film, the intermediate layer is a conductive layer or a conductive layer having a current confining region. Specifically, Al, Cu, Ag, Au, or a mixture of them or a stacked body of them may be used for the conductive layer, in addition, a region for current confining may be inserted into the conductive layer by partially oxidizing or nitriding part of the conductive layer. Again in this case, the air-bearing surface protection layer is reduced in thickness, and reduction in the S/N ratio of the read element is suppressed, whereby a magnetic head suitable for high density recording can be provided at a high yield.

What is claimed is:

1. A magnetic head, including a read element having
a magnetoresistive effect film having an intermediate layer between a ferromagnetic pinned layer and a ferromagnetic free layer, and
a lower electrode layer and an upper electrode layer disposed below and above the magnetoresistive effect film, the magnetic head characterized in that:
the intermediate layer is a tunnel barrier layer having a high resistance characteristic, and
an air-bearing surface protection layer formed on a surface of the read element at a side of a recording medium facing surface includes a silicon nitride film.

2. The magnetic head according to claim 1, characterized in that:
the thickness of the air-bearing surface protection layer is 2.5 nm or less, and
a component ratio of nitrogen in the air-bearing surface protection layer is 35 at % to 60 at %.

3. The magnetic head according to claim 1, characterized in that:
the intermediate layer is made of magnesium oxide.

4. The magnetic head according to claim 1, characterized in that:
the lower electrode layer and the upper electrode layer are made of a soft magnetic material respectively.

5. The magnetic head according to claim 2, characterized in that:
the lower electrode layer and the upper electrode layer are made of a soft magnetic material respectively.

6. The magnetic head according to claim 3, characterized in that:
the lower electrode layer and the upper electrode layer are made of a soft magnetic material respectively.

7. The magnetic head according to claim 1, characterized by further including:
a magnetic induction write element provided adjacently to the read element.

8. The magnetic head according to claim 2, characterized by further including:
a magnetic induction write element provided adjacently to the read element.

9. The magnetic head according to claim 3, characterized by further including:
a magnetic induction write element provided adjacently to the read element.

10. The magnetic head according to claim 4, characterized by further including:
a magnetic induction write element provided adjacently to the read element.

11. The magnetic head according to claim 5, characterized by further including:
a magnetic induction write element provided adjacently to the read element.

12. The magnetic head according to claim 6, characterized by further including:
a magnetic induction write element provided adjacently to the read element.

13. The magnetic head according to claim 7, characterized by further including:
a magnetic induction write element provided adjacently to the read element.

14. A magnetic head, including a read element having
a magnetoresistive effect film having an intermediate layer between a ferromagnetic pinned layer and a ferromagnetic free layer, and
a lower electrode layer and an upper electrode layer disposed below and above the magnetoresistive effect film, the magnetic head characterized in that:
the intermediate layer is a tunnel barrier layer having a high resistance characteristic, and
an air-bearing surface protection layer, in which an adhesion film including a silicon nitride film is disposed as a lower layer and an air-bearing surface protection film containing carbon is disposed as an upper layer, is provided on a surface of the read element at a side of a recording medium facing surface.

15. The magnetic head according to claim 14, characterized in that:
the content of nitrogen in the air-bearing surface protection film is 35 at % to 60 at %, and
the total thickness of the adhesion film and the air-bearing surface protection film is 2.5 nm or less.

16. The magnetic head according to claim 14, characterized in that:
when it is assumed that stopping power of the adhesion film is dE/dx, and initial energy of a carbon ion in formation of the air-bearing surface protection film is Ei, the thickness of the adhesion film is Ei/(dE/dx) or more.

17. The magnetic head according to claim 14, characterized by further including:
a magnetic induction write element disposed adjacently to the read element.

18. The magnetic head according to claim 16, characterized by further including:
a magnetic induction write element disposed adjacently to the read element.

19. A method of manufacturing a magnetic head, characterized by having:
a step of forming a plurality of magnetic head elements, each having a magnetoresistive effect film, on a wafer,
a step of cutting the wafer into a row bar,
a step of mechanically polishing an air-bearing surface of the row bar,
a step of cleaning the mechanically polished air-bearing surface using an ion beam or gas plasma,
a step of forming an adhesion film including silicon nitride having a nitrogen content of 35 at % to 60 at % on the air-bearing surface subjected to cleaning,
a step of forming an air-bearing surface protection film containing carbon by a film formation method having initial energy in such a level that a carbon ion does not penetrate the adhesion film, following formation of the adhesion film,
a step of forming a rail on the air-bearing surface on which the air-bearing surface protection film was formed, and
a step of cutting the row bar into individual pieces of the magnetic head elements.

20. The method of manufacturing a magnetic head according to claim 19, characterized in that:
the air-bearing surface protection film is formed using cathodic vacuum arc deposition.

21. The method of manufacturing a magnetic head according to claim 19, characterized in that:
the air-bearing surface protection film is formed using sputtering.
